(19) United States
(12) Patent Application Publication
(10) Pub. No.: US 2022/0240618 A1
(43) Pub. Date: Aug. 4, 2022

(54) LEG LENGTH SHIM FOR USE WITH A CYCLING SHOE

(71) Applicant: Ronan Descy, Totnes (GB)

(72) Inventor: Ronan Descy, Totnes (GB)

(21) Appl. No.: 17/596,317

(22) PCT Filed: Jun. 5, 2020
(86) PCT No.: PCT/GB2020/051372

§ 371 Date: Dec. 7, 2021

(30) Foreign Application Priority Data
Jun. 7, 2019 (GB) 1908177.7

(51) Int. Cl. A43B 5/14; B62M 3/08

(52) U.S. Cl. CPC A43B 5/14; B62M 3/086

(57) ABSTRACT

This specification describes a leg length shim for use with a cycling shoe. For instance, the specification describes a leg length shim for coupling to a sole of a cycling shoe in order to correct a leg length discrepancy, comprising a shim body having an upper surface and a lower surface, wherein, when the leg length shim is coupled to a sole of the cycling shoe, the upper surface faces towards the sole of the cycling shoe and the lower surface faces away from the sole of the cycling shoe; and at least one tread element extending from the lower surface of the shim body in a direction away from the sole of the shoe.

### BACKGROUND

Cycling shoes often include cleats which lock into clipless pedals of a bicycle. Cycling shoes are generally grouped into two categories—road bike shoes and mountain bike shoes. Mountain bike shoes often include a tread which extends further downwards than the cleat on the mountain bike shoe. The tread prevents the cleat from contacting the ground during walking and allows a user to walk in the mountain bike shoe in off-road conditions, as well as on regular roads and tarmac. These off road conditions may include gravel, rocks, loose dirt, positive or negative gradients, or otherwise unstable surfaces.

Conventional leg length shims are provided between the sole of a cycling shoe and its cleat in order to correct a leg length discrepancy. A leg length discrepancy arises when a rider has legs which differ in length, which may occur naturally or as a result of an injury. A leg length discrepancy may cause discomfort or reduced cycling efficiency. As such, conventional leg length shims, when used with mountain bike shoes, can cause the cleat of the mountain bike shoe to extend past the tread of the shoe. In this case, the mountain bike shoe would be difficult or dangerous to walk in, both on and off-road. For instance, the cleat contacting the ground when walking on hard surfaces (e.g. man-made surfaces) may result in a user having very little grip, making the activity dangerous and unstable. In some situations, the mountain bike shoe cleat may also be damaged during walking. In addition, as a result of the conventional leg length shim spacing the cleat from the mountain bike shoe, a user may find it more difficult to clip in to the pedals of a bike. The conventional leg length shim may also cause instability of the mountain bike shoe on the pedal during riding of the bike.

FIG. 6A illustrates an example of a cycling shoe including a tread, and also a cleat which is not coupled to the cycling shoe. The cycling shoe 60 may include a sole 61. The cycling shoe 60 may include at least one cleat mounting hole 62 positioned on the sole 6i. The cleat 63 may be mounted to the cycling shoe 60 by at least one fixing device 65 protruding through the cleat 63 and into the cleat mounting holes 62. The cycling shoe 60 may include a tread 64 protruding downwards from the sole 6i. The tread 64 may be configured to prevent the cleat 63 from contacting the ground when the cycling shoe 60 is walked in.

### SUMMARY

This specification describes a leg length shim which may address a number of the above-described drawbacks and limitations associated with conventional leg length shims.

Accordingly in a first aspect, this specification describes a leg length shim for coupling to a sole of a cycling shoe in order to correct a leg length discrepancy, comprising: a shim body having an upper surface and a lower surface, wherein, when the leg length shim is coupled to a sole of the cycling shoe, the upper surface faces towards the sole of the cycling shoe and the lower surface faces away from the sole of the cycling shoe; and at least one tread element extending from the lower surface of the shim body in a direction away from the sole of the shoe. At least some of the tread elements may extend outside a perimeter of the shim body.

At least some of the tread elements may include a first portion and a second portion, wherein the first portion extends from the shim body to the second portion, and the second portion extends outside the perimeter of the shim body, and wherein, when the leg length shim is coupled to the sole of the cycling shoe, a lower surface of the second portion is configured to contact a surface upon which the wearer of the cycling shoe is walking. In such examples, the first and second portions of the tread elements may together define a volume to receive a tread of a cycling shoe. An outer surface of the first portion and an upper surface of the second portion may define the volume for receiving a tread of a cycling shoe, the outer surface of the first portion and the upper surface of the second portion sharing a common edge.

The first portion and the second portion may together form a channel to receive a tread of the cycling shoe. The first portion may extend generally away from the sole, and the second portion extends generally perpendicular to the sole. The first portion may extend such that the second portion is further from the sole of the cycling shoe than is a bottom of a tread of the cycling shoe when the leg length shim is coupled to the sole of the cycling shoe.

The tread elements may comprise a guide edge, wherein the guide edge is positioned at a forward facing end of the tread elements, the forward facing end of the tread elements being an end of the tread elements closest to a front of the cycling shoe when the leg length shim is coupled to the sole of the cycling shoe, and wherein the guide edge is configured to guide a pedal locking mechanism of a pedal towards a cleat coupled to the cycling shoe. The tread elements may comprise an angled edge configured to allow debris to pass more easily away from a cleat coupled to the cycling shoe. The tread elements may be formed of a material having at least one of: a high abrasion resistance, a high coefficient of friction, and a high shear strength.

The leg length shim may further comprise at least one mating protrusion protruding from an upper surface of the shim body, wherein each of the at least one mating protrusion is configured to mate with a cleat mounting hole or mounting hole slots of the cycling shoe, and the leg length shim and a cleat are coupled to the cycling shoe by at least one fixing device configured to protrude through the cleat, the leg length shim and the cleat mounting hole.

The tread elements may comprise two front feet. In such examples, the front feet may be positioned at a front end of the shim body and may be spaced apart from one another. The tread elements may further comprise two rear feet. The rear feet may be positioned at a rear end of the shim body and may be spaced apart from one another. The front feet may be spaced apart from the rear feet. Alternatively, the tread elements may further comprise a single rear foot. In such examples, the rear foot may extend substantially across the rear end of the shim body, and the front feet are spaced apart from the rear foot.

The leg length shim may further comprise a recessed portion in a lower surface of the shim body configured to receive an insert. In such examples, the leg length shim may further comprise an insert configured to be inserted into the recessed portion. The insert may be formed of a material which has a hardness greater than a hardness of a material forming the shim body. Additionally or alternatively, the insert may comprise at least one side tab on each opposite side surface of the insert, and wherein the side tabs are configured to contact an inside surface of the tread of the cycling shoe. At least some of the side tabs may be configured to be removed such that the total width of the insert is reduced.

The shim body may be formed of two components, each component having at least one tread element extending therefrom, wherein the relative positions of the two components can be adjusted, thereby to adjust the width of the leg length shim.

### BRIEF DESCRIPTION OF THE FIGURES

For a more complete understanding of the leg length shims described herein, reference is now made to the following description taken in connection with the accompanying Figures, in which: Figures iA to 1D illustrate an example of a leg length shim;

FIG. 1E is a view of the leg length shim of FIG. 1A to 1D coupled to a cycling shoe having a tread;

FIGS. 2A to 2C illustrate an example of an insert for use with a leg length shim such as that of FIGS. 1A to 1D;
FIGS. 3A to 3C illustrate another example of an insert for use with the leg length shim such as that of FIGS. 1A to 1D;

FIGS. 4A and 4B illustrate an example of an additional shim element for use with the leg length shim such as that of FIGS. 1A to 1D;

FIGS. 5A and 5B illustrate an example of a leg length shim such as that of FIGS. 1A to 1D, an insert such as that of FIGS. 2A to 2C, and an additional shim element such as that of FIGS. 4A and 4B;

FIG. 6A illustrates an example of a cycling shoe and a cleat;

FIG. 6B illustrates an example of a leg length shim such as that of FIGS. 1A to 1D coupled with a cycling shoe and cleat such as that of FIG. 6A, and a pedal.

### DETAILED DESCRIPTION

In the description and drawings, like reference numerals may refer to like elements throughout.

This application describes a leg length shim capable of being used with cycling shoes having a tread. The leg length shim corrects a leg length discrepancy for riders using such shoes, whilst providing additional tread elements to prevent the cleat of the cycling shoe from contacting the ground during walking in the cycling shoes. The leg length shim prevents damage from being caused to the cleat and provides improved grip for a user wearing the cycling shoe whilst walking, particularly in off-road conditions. The leg length shim also does not interfere with the ability of the rider to clip in to or out of a clipless pedal.

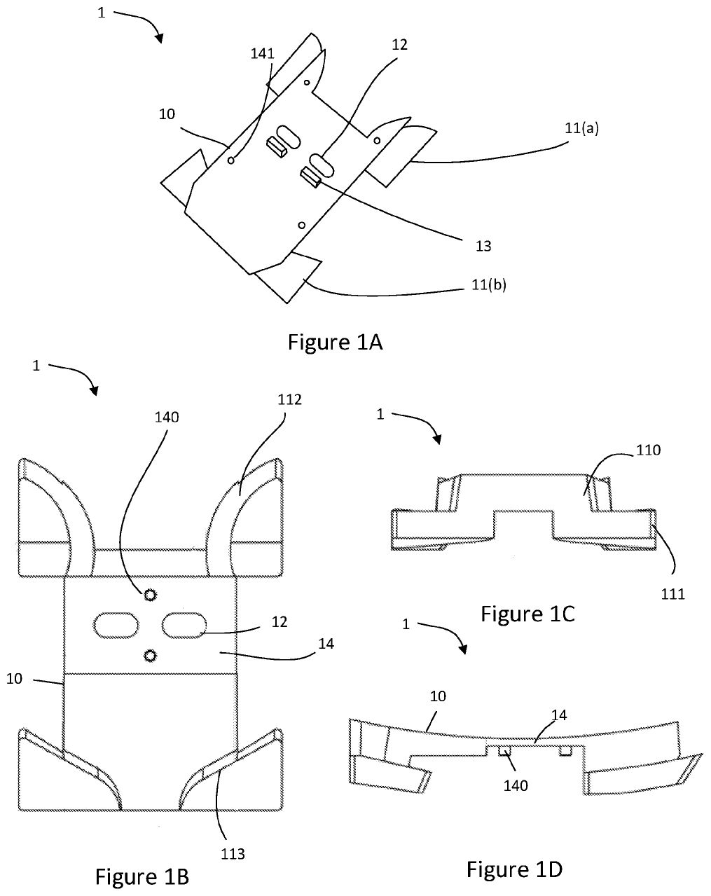

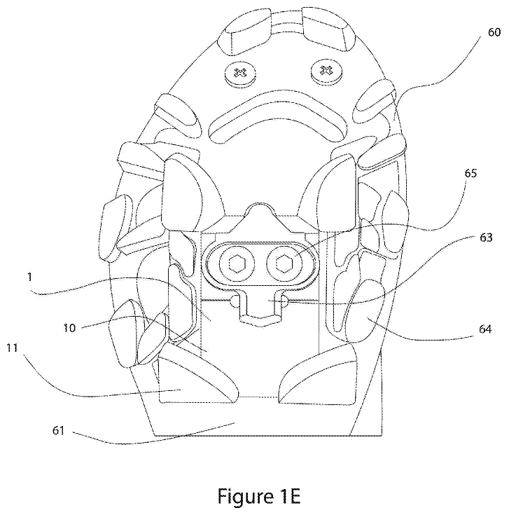

FIGS. 1A to 1D illustrate an example of a leg length shim 1. FIG. 1E is a view of the leg length shim of Figures Iowa to 1D coupled to a cycling shoe having a tread.

The leg length shim 1 may be configured to be coupled to a sole 61 of a cycling shoe 60 in order to correct a leg length discrepancy. As can be seen in FIG. 1E, the leg length shim 1 may be configured to space the sole 61 of the cycling shoe 60 from a cleat 63 which is to be coupled to the cycling shoe 60.

The leg length shim 1 may include a shim body 10. The shim body 10 may include an upper surface which, when the leg length shim 1 is coupled to the sole of the cycling shoe, faces towards the sole of the cycling shoe. The shim body 10 may also include a lower surface which, when the leg length shim 1 is coupled to the sole of the cycling shoe, faces away from the sole of the cycling shoe.

The shim body 10 may be substantially square or rectangular. However, the shape of the shim body 10 may be any shape and is not limited to being substantially square or rectangular. The shim body 10 may have a thickness which is significantly smaller than the length or the width of the shim body 10. In some examples, the thickness of the shim body 10 may be substantially uniform across the width and the length of the shim body 10. In other examples, the thickness of the shim body 10 may vary across the length and/or the width of the shim body 10. The shim body 10 may be curved in one or more directions. The shim body may be configured to substantially match the profile of the sole of the cycling shoe. In the example of FIG. 1D, the upper surface of the shim body 10 may be shaped to correspond to the profile of the sole of the cycling shoe, and the lower surface may be substantially flat. As will be appreciated from the discussion below, part of the lower surface may be formed by an insert 20 (see FIGS. 2A to 2C, 3A to 3C and 5B).

The shim body 10 may be configured to engage with the sole of the shoe. The shim body 10 may be configured to cover an area of the sole of the shoe when it is engaged with the sole of the shoe. The shim body 10 may comprise a plate for separating/spacing the cleat from the sole of the shoe. The shim body 10 may be configured to separate the cleat from the sole of the shoe by substantially the thickness of the shim body 10.

The leg length shim 1 may include one or more tread elements 11. The tread elements 11 may project in a direction generally away from the lower surface of the shim body 10. The tread elements 11 may extend outside of a perimeter of the shim body 10. The tread elements 11 may be configured to extend further from the sole of the cycling shoe than does the cleat when the cleat and the leg length shim 1 are coupled to the cycling shoe.

The tread elements 11 may be configured to extend further from the sole of the cycling shoe than does the tread of the cycling shoe. In some examples, the tread elements 11 may be configured to extend over (or cover) a bottom surface of the treads of the cycling shoe.

The tread elements 11 may include a first portion no and a second portion 111. The first portion no may extend from the shim body 10 to the second portion 111. The first portion no may extend in a direction which is substantially away from the sole of the cycling shoe when the leg length shim 1 is coupled to the sole of the cycling shoe. The first portion no may have a length such that, when the leg length shim 1 is coupled to the cycling shoe, the second portion in may be further from the sole of the cycling shoe than is a bottom of the tread of the cycling shoe. The first portion no may include an outer surface which faces away from the centre of the shim body 10 in a side direction (the side direction being generally perpendicular to the length of the cycling shoe and generally parallel to the sole of the cycling shoe).

The second portion 111 may extend outside the perimeter of the shim body 10. The second portion 111 may be configured to cover at least part of the treads of the cycling shoe when the leg length shim 1 is coupled to the sole of the cycling shoe. The second portion 111 may have a thickness such that, when the cleat and the leg length shim 1 are coupled to the cycling shoe, the cleat does not extend past the second portion 111. In addition or alternatively, the thickness of the second portion 111 may be selected such that it still enables the cleat to be “clipped in” to a pedal. The second portion 111 may include a lower surface which may be configured, when the leg length shim 1 is coupled to the sole of the cycling shoe, to contact the ground during walking. The second portion 111 may have an upper surface which is opposite the lower surface. Put another way, the upper surface may face generally towards the sole of the cycling shoe. The upper surface of the second portion 111 may share an edge with the outer surface of the first portion no. The upper surface of the second portion 111 may be configured to cover the tread of the cycling shoe when the leg length shim 1 is coupled with the cycling shoe. In some implementations, depending on the dimensions of the first portion no and the height of the tread, the upper surface of the second portion 111 may come into contact with the tread of the cycling shoe.

The outer surface of the first portion no and the upper surface of the second portion 111 may extend substantially perpendicularly to one another. For instance, they may form an L-shape. The first portion 110 and the second portion in of the tread elements 11 may together define a volume for receiving the tread of the cycling shoe. The volume for receiving the tread of the cycling shoe may be formed by the outer surface of the first portion 110 together with the upper surface of the second portion 111. In other words, the first portion 110 and the second portion 111 may form a channel to receive the tread of the cycling shoe. The channel to receive the tread of the cycling shoe may have any shape by which the tread of the cycling shoe may be at least partially covered. As will be appreciated, the shape of the channel may be dependent on the relative arrangement and configurations of the first portion 110 and the second portion 111.

As can be seen in FIG. 1E, the shim body 10 and the tread elements 11 may be arranged such that the shim body 10 sits, adjacent the sole 61 of the cycling shoe 60, in a recess formed by the treads 64 of the cycling shoe 60. The tread elements 11 of the leg length shim 1 may extend from the shim body 10 such that a (second) portion in of the tread elements 11 cover (or extend over) at least part of the walking surface of the treads 64 of the cycling shoe 60. The first portion 110 of the tread elements 11 may extend away from the sole 61 of the cycling shoe 60 alongside an inner surface of the treads 64 of the cycling shoe 60.

When the leg length shim 1 is coupled to the cycling shoe, the cleat may be caused to protrude past the treads of the cycling shoe. The tread elements 11 of the leg length shim 1 may, in effect, add to the downward length of the tread of the cycling shoe so that the cleat does not protrude past the tread elements 11. As a result, the cleat may be prevented from contacting the ground. The leg length shim 1 may protect the cleat from damage when a user wearing the cycling shoe is walking. Furthermore, the leg length shim 1 may improve a user's ability to walk when wearing the cycling shoe, particularly in off-road conditions which may include unstable surfaces.

The tread elements 11 may include one or more front feet 11a. For instance, the tread elements 11 may include two front feet 11a. However, in some examples, the tread elements 11 may include fewer or more than two front feet 11a. The front feet 11a may be positioned at a front end of the shim body 10. The front end of the shim body 10 may be an end of the shim body 10 which, when the leg length shim 1 is coupled to the sole of the cycling shoe, is closest to a front of the cycling shoe.

The front feet 11a may be spaced apart from one another. For instance, in examples where there are two front feet 11a, the front feet 11a may extend from side edges of the front end of the shim body 10. However, in other examples where there are two front feet 11a, the front feet 11a may extend from an interior region of the shim body 10, away from the side edges and/or the front end. The front feet 11a may be positioned symmetrically at the front end of the shim body 10. The front feet 11a may be positioned such that the cleat is able to pass between the front feet 11a when the cleat is being “clipped in” to the pedal. In some other examples, the front feet 11a may not be spaced apart from one another. For instance, the front feet 11a may extend across the front end of the of the shim body 10 to meet each other.

The tread elements 11 may include one or more rear feet 11b. For instance, the tread elements 11 may include a single rear foot 11b or two rear feet 11b. In some examples, the tread elements 11 may include more than two rear feet 11b. The rear feet 11b may be positioned at a rear end of the shim body 10. The rear end of the shim body 10 may be an end of the shim body 10 which, when the leg length shim 1 is coupled to the sole of the cycling shoe, is closest to a rear of the cycling shoe.

The rear feet 11b may be spaced apart from one another. For instance, in examples where there are two rear feet 11b, the rear feet 11b may extend from side edges of the rear end of the shim body 10. However, in other examples where there are two rear feet 11b, the rear feet 11b may extend from an interior region of the shim body 10, away from the side edges and/or the rear end. The rear feet 11a may be positioned symmetrically at the rear end of the shim body 10. The rear feet 11b may be spaced apart from one another such that any debris which has been picked up during use of the cycling shoe may pass between the rear feet 11b, thereby reducing instances of debris interfering with the cleat when being “clipped in” to the pedal.

In some examples where the tread elements 11 include a single rear foot 11b, the rear foot 11b may extend across the entire width of the back end of the shim body 10, may extend further than the width of the back end of the shim body 10, or may extend across part of the width of the back end of the shim body 10. The single rear foot 11b may be positioned centrally.

The front feet 11a of the tread elements 11 may be spaced apart from the rear feet 11b of the tread elements 11. The front feet 11a and the rear feet 11b may be positioned such that the tread elements 11 do not interfere with an “unclipping” (e.g. a twisting action) of the cleat of the cycling shoe. In examples in which the shim body 10 is substantially rectangular or square, the front feet 11a and the rear feet 11b may extend from the corners of the shim body 10. In some other examples, the front feet 11a may not be spaced apart from the rear feet 11b. For instance, the front feet 11a may extend to meet the rear feet 11b such that they together form a single continuous tread element 11 on each side of the shim body 10.

In other examples, the leg length shim 1 may not include any rear feet 11b. In yet other examples, the leg length shim 1 may additionally or alternatively include mid feet (not shown) which may be positioned between the front end and the rear end. In examples including front feet, the mid feet may extend towards and contact the front feet such that the front feet and the mid feet may together form a single foot on each side of the shim body 10. In examples including rear feet, the mid feet may extend towards the rear feet such that the rear feet and the mid feet may together form a single foot on each side of the shim body 10. In some other examples, the mid feet may not extend towards the front feet and/or the rear feet such that the mid feet may be spaced apart from the front feet and/or the rear feet.

One or more of the tread elements 11 may include a guide edge 112 for guiding a pedal locking mechanism of the pedal between the tread elements 11 towards the cleat of the cycling shoe as the cleat is being “clipped in” to the pedal. The guide edge 112 may be positioned on the front feet 11a of the tread elements 11. The guide edge 112 may be positioned at a forward facing end of the tread elements 11, where the forward facing end of the tread elements 11 may be an end of the tread elements 11 closest to a front of the cycling shoe when the leg length shim 1 is coupled to the sole of the cycling shoe.

The guide edge may be generally angled towards the centre of the shim body. In some examples the guide edge may include a single straight portion. In other examples the guide edge may include a plurality of straight portions. For instance, the guide edge may include a bevelled portion. In yet other examples, the guide edge may, in addition or alternatively, include at least one curved portion. For instance the guide edge may include a chamfered portion.

In some examples, the shim body 10 may additionally or alternatively include a guide area (not shown). The guide area may be positioned on the front end of the shim body.

As a result of the guide edge 112, or otherwise (e.g. the guide area), the leg length shim 1 may guide the cleat into position when the cleat is being “clipped in” to the pedal. The leg length shim 1 may allow a user of the cycling shoe, with the leg length shim 1 fitted, to easily “clip in”. Thus, the leg length shim 1 may improve the ease of use of the cycling shoe having the leg length shim 1 fitted, compared with, for instance, a cycling shoe having a conventional leg length shim fitted.

One or more of the tread elements 11 may include an angled edge 113. For instance, the angled edge 113 may be provided on the rear feet 11b of the tread elements 11. The angled edge 113 may be configured by virtue of its shape to allow debris to pass more easily away from the cleat of the cycling shoe and between, e.g. the rear tread elements 11b. For instance, the angled edge 113 may have a shape configured to create an area which does not restrict the debris from falling away. The angled edge 113 may also be configured to discourage dirt from gathering under the shim body 10 due to the angle of the angled edge 113 against the shim body 10. The angle of the angled edge 113 against the shim body 10 may be greater than 90 degrees. The debris may comprise mud, soil, dirt, sediment, sand, snow and/or any other foreign substance.

The angled edge may be generally angled towards the centre of the shim body. In some examples the angled edge 113 may include a single straight edge. In other examples the angled edge 113 may include a plurality of straight edge. For instance, the angled edge 113 may include a bevelled edge. In yet other examples, the angled edge 113 may, in addition or alternatively, include at least one curved edge. For instance the angled edge 113 may include a chamfered edge. Although there may be benefits to the angled edge 113, the leg length shim 1 may allow debris to pass between the rear tread elements 11b even when the angled edge 113 is not included.

The shim body 10 may include at least one through hole 12. For instance, the shim body 10 may include two through holes 12. The through holes 12 may be configured to correspond to at least one cleat mounting hole in the sole of the cycling shoe. The cleat may be coupled to the cycling shoe by at least one fixing device protruding through the cleat, through the through hole 12 and into the cleat mounting hole of the sole of the shoe. The leg length shim 1 may thus be secured between the cleat and the sole of the cycling shoe In addition or alternatively, the leg length shim 1 may be coupled to the cycling shoe with adhesive or some other fixing means unrelated to the cleat.

The shim body 10 may include at least one mating protrusion 13. For instance, the shim body 10 may include two mating protrusions 13. The mating protrusions 13 may protrude from the upper surface of the shim body 10. In some examples, the mating protrusions 13 may have a substantially rectangular cross section. In other examples, the mating protrusions 13 may not have a rectangular cross section, e.g. the mating protrusions 13 may have a circular cross section or a square cross section. The mating protrusions 13 may be arranged so as to mate with the cleat mounting holes. The mating protrusions 13 may contact at least one surface in the cleat mounting holes. The shape of the mating protrusions 13 may be configured to maximise the surface area of the surface in the cleat mounting hole which may be contacted by the mating protrusion 13. The mating protrusions 13 may have a length in the range of approximately 4 mm to 4.5 mm. In other examples, the mating protrusions may be longer than 4.5 mm (for instance, 10 mm) and may adjusted (e.g. cut) to the desired size. In other examples, the mating protrusions 13 may be arranged so as to mate with holes in the cycling shoe other than the cleat mounting holes. As a result of the mating protrusions 13 or otherwise, the leg length shim 1 may be prevented from rotating when torque is applied to the cleat, e.g. when “clipping out” or cycling.

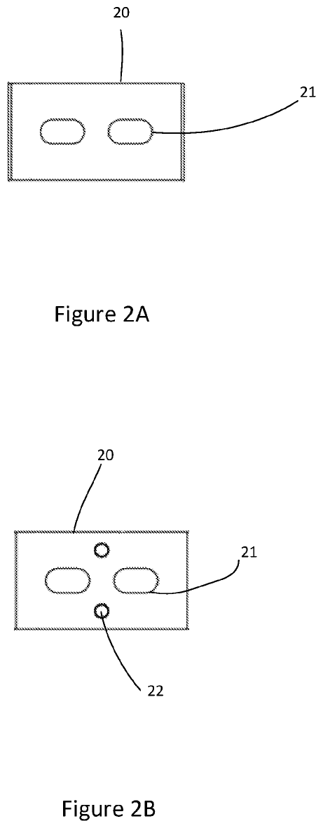

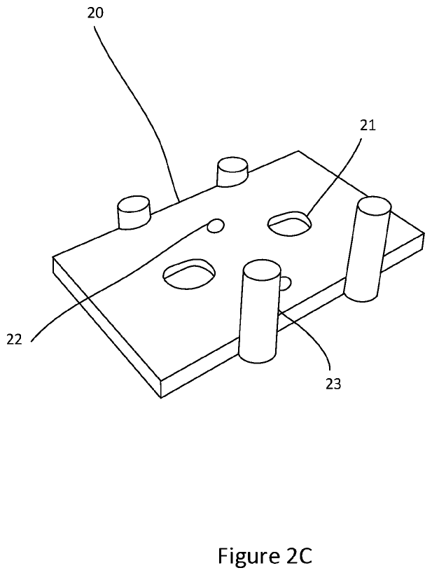

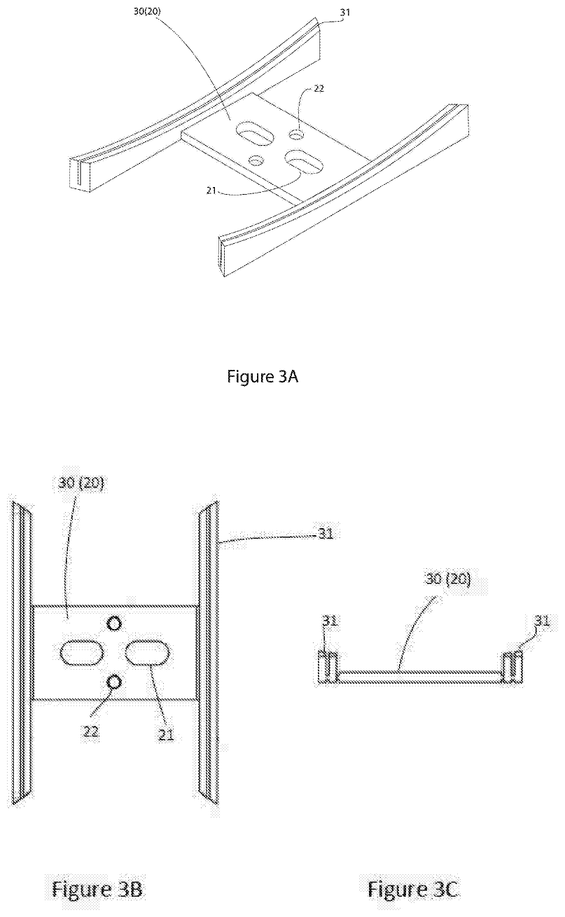

The shim body 10 may include a recessed portion 14. The recessed portion 14 may be formed on the lower surface of the shim body 10. The recessed portion 14 may be a portion of the shim body 10 which has a reduced thickness relative to the rest of the shim body 10. For instance, the recessed portion 14 may have a thickness of approximately 1.5 mm. In some other examples, the recessed portion 14 may have a thickness greater than approximately 1.5 mm. The through holes 12 may be formed in the recessed portion 14. The recessed portion 14 may be configured to receive an insert 20 (see e.g. FIGS. 2A to 2C and 3A to 3C). As is discussed below, the insert 20 may be of various different types and may serve various different functions. The recessed portion 14 may comprise at least one insert fixing protrusion 140, which is configured to mate with a corresponding insert fixing hole 22 formed in the insert 20. The insert fixing protrusion 140 may protrude downwards from the recessed portion 14. The insert fixing protrusion 140 may have any suitable shape, such as but not limited to a pin shape. In other examples, the insert 20 may include the insert fixing protrusion 140 and the shim body 10 may include the insert fixing hole 22.

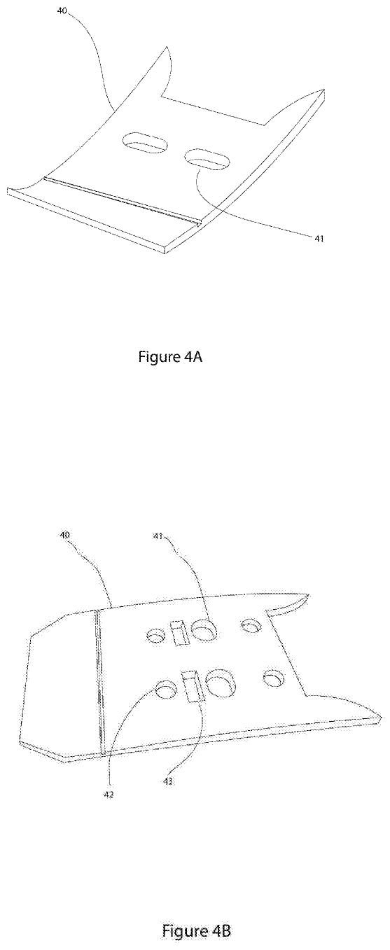

The shim body 10 may include at least one shim element fixing hole 141 for receiving corresponding shim element fixing protrusions (not shown) formed in an additional shim element 40 (see FIGS. 4A and 4B) The additional shim element 40 may be for increasing overall separation between the cleat and the sole of the cycling shoe. The shim element fixing holes 141 may be positioned on the upper surface of the shim body 10. In other examples, the additional shim element 40 may include the shim element fixing hole 141 and the shim body 10 may include the shim element fixing protrusion.

The shim body 10 may be configured to have an adjustable width. For instance the shim body 10 may be formed of a plurality of components which may be adjustably separated from each other such that the overall width of the shim body 10 is adjustable. For example, the plurality of components may include a left component and a right component formed by the shim body 10, as illustrated in FIGS. 1A to 1D, being separated down the middle. The spacing between the left and right components may be adjusted by a user in order to adjust the overall width of the shim body 10. The tread elements 11 may extend from the left and the right components of the shim body 10 in substantially the same way as shown in FIGS. 1A to 1D, or as described above. The plurality of components of the shim body 10 may be adjustably connected to each other such that they may be adjustably separated from each other whilst maintaining their structure. The width of the shim body 10 may be adjusted based on a width of the treads of the sole of the cycling shoe.

The shim body 10 and the tread elements 11 of the leg length shim 1 may be integrally formed. However, in some examples, the shim body 10 and the tread elements 11 may be formed of two or more components.

The leg length shim 1 may be formed by any suitable manufacturing process. For instance, the leg length shim 1 may be formed by injection moulding and/or 3d printing.

The materials used to form the leg length shim 1 may have a high abrasion resistance. In addition or alternatively, the materials used to form the leg length shim 1 may have a high shear strength. As a result, or otherwise, the leg length shim 1 may be durable and hard wearing. This may be beneficial when the leg length shim 1 is used in both on and off-road conditions. The material may be such that the tread elements 11 of the leg length shim 1 hold their shape even when they are not supported by the tread of the cycling shoe. The material for the leg length shim 1 may be selected so as to provide improved grip during walking. For instance, it may be selected so as to have a high traction.

In some examples, the leg length shim 1 may include hard wearing plastic having elastic properties. For instance, the leg length shim 1 may include thermoplastic elastomer (TPE), thermoplastic polyurethane (TPU), or a mixture of a plastic material (e.g. polypropylene) and a rubber material. In other examples, the leg length shim 1 may include a hard material (e.g. nylon). In yet other examples, the leg length shim 1 may additionally or alternatively include a rubber material, such as Vibram.

In some examples, the leg length shim 1 may additionally or alternatively include a metal material. For instance, the shim body 10, the tread elements 11, an insert 20 as illustrated in FIGS. 2A to 2C and 3A to 3C, and/or an additional shim element 40 as illustrated in FIGS. 4A and 4B may include a metal material.

As mentioned above, the leg length shim 1 may include an insert 20 as illustrated in FIGS. 2A to 2C. The insert 20 may be configured to be inserted into the recessed portion 14.

The insert 20 may be formed of a hard material. For instance, the insert 20 may be formed of a material which has a hardness greater than the hardness of the material(s) used to form the shim body 10. For instance, the insert 20 may include nylon, polypropylene, carbon fibre, glass fibre, or a mixture of materials (e.g. glass impregnated nylon). The insert 20 may increase the resistance (e.g. friction) between the leg length shim 10 and the cleat. As a result, the insert may reduce rotation of the leg length shim 1 when torque is applied to the cleat.

The insert 20 may include at least one insert through hole 21. The insert through hole 21 may be configured to correspond to the through hole 12 of the shim body 10 and/or the cleat mounting hole of the cycling shoe. The insert 20 may be configured to be coupled to the shim body 10, the cleat, and/or the cycling shoe by the at least one fixing device which may protrude through the insert through hole 21.

The insert 20 may have a first side configured to contact the recessed portion 14, and a second side opposite the first side. The first side of the insert 20 may include at least one insert fixing hole 22. The insert fixing holes 22 may correspond to the insert fixing protrusions 140 of the recessed portion 14. The insert fixing protrusions 140 may mate with the insert fixing holes 22 which may help the insert 20 to be positioned on and/or fixed to the recessed portion 14. In other examples, the insert 20 may include the insert fixing protrusions 140 and the shim body 10 may include the insert fixing holes 22.

In addition or alternatively, as illustrated in FIG. 2C, the insert 20 may include at least one prong 23, and the recessed portion 14 may include at least one prong through hole (not shown) corresponding to the prong 23. When the insert 20 is inserted in to the recessed portion 14, the prong 23 of the insert 20 may protrude through the prong through hole of the recessed portion 14. The prong 23 may be positioned more towards a first end of the insert 20 than a second end of the insert 20, the second end opposite the first end. As such, the insert 20 may be more easily positioned on and/or fixed to the recessed portion 14. In addition, the prong 23 may perform similar functions to that of the mating protrusion 13. In some examples, the insert may be rotated 180 degrees with the prongs being inserted into either the fore or aft holes in cycling shoes (i.e. the holes which are not being used to secure the cleat to the shoe). This may allow flexibility in the positioning of the cleat.

In some examples, the insert 20 may, together with the recessed portion 14, have a combined thickness of approximately 3.5 mm. For instance, when the recessed portion 14 has a thickness of approximately 1.5 mm, the insert 20 may have a thickness of 2 mm. However, in some other examples, the insert 20 and the recessed portion 14 may be configured to have a combined thickness corresponding to a leg length discrepancy which may be greater or less than approximately 3.5 mm.

In some examples, the insert 20 may include at least one side tab 31 as illustrated in FIGS. 3A to 3C. In such examples, the insert 20 may be referred to as an H piece 30. The H piece 30 may have a shape resembling an H. The side tabs 31 may be positioned on each side of the H piece 30. The side tabs 31 may extend such that, when the H piece 30 is inserted into the recessed portion 14 of the shim body 10, the side tabs 31 run parallel to the length of the shim body 10. For instance, the side tabs 31 may have a length substantially the same as the length of the shim body 10. When the H piece 30 is inserted into the recessed portion 14 of the shim body 10, the side tabs 31 may extend from the rear end of the shim body 10 to the front end of the shim body 10.

The side tabs 31 may be configured to have a width such that the H piece 30, when inserted into the recessed portion 14 and the leg length shim 1 is coupled with the cycling shoe, may contact the shim body 10 and the tread of the cycling shoe. The H piece 30 may be configured to limit the distance by which the leg length shim 1 may rotate by the side tabs 31 contacting the shim body 10 and the inside surfaces of the tread of the cycling shoe. As a result, or otherwise, the H piece 30 may restrict the leg length shim 1 from rotating when torque is applied to the cleat.

The side tabs 31 may be configured to have a variable width. In some examples, at least some of the side tabs 31 may be removed (e.g. trimmed) by a user so that the user may adjust the width of the side tabs 31 to a desired width. In such examples, the side tabs 31 may include at least one tab which may be removed (e.g. trimmed) to reduce the overall width of the side tabs. As a result or otherwise, the side tabs 31 may be modified by the user in order to fit the distance between the treads of a particular cycling shoe.

The leg length shim 1 may include one or more additional shim elements 40 as illustrated in FIGS. 4A and 4B. The one or more additional shim elements 40 may increase the separation between the cleat and the sole of the cycling shoe. The number of additional shim elements 40 used may be dependent on the leg length discrepancy.

The additional shim element 40 may be configured to be placed on the upper surface of the shim body 10. In some examples, the additional shim element 40 may be configured to clip in to the shim body 10. The additional shim element 40 may include at least one shim element through hole 41. The shim element through hole 41 may be configured to correspond to the through hole 12 of the shim body 10 and/or the cleat mounting hole of the cycling shoe. The additional shim element 40 may be configured to be coupled to the shim body 10, the cleat, and/or the cycling shoe by the at least one fixing device which may protrude through the shim element through hole 41.

The additional shim element 40 may further include at least one mating protrusion hole 43. The mating protrusion holes 43 may correspond to the mating protrusions 13 so that the mating protrusions 13 do not interfere with the additional shim element 40 coming into contact with the upper surface of the shim body 10, and the mating protrusions 13 are not prevented from mating with the sole of the cycling shoe. The mating protrusion holes may be integrally formed with the shim element through holes 41. The additional shim element 40 may include prong through holes 42 which correspond to the prongs 23 of the insert 20. The prong through holes 42 of the additional shim insert 40 may perform similar functions to those described in relation to the prong through holes of the recessed portion 40.

The additional shim element 40 may include a first side configured to contact the upper surface of the shim body 10, and a second side opposite the first side. The first side of the additional shim element 40 may include at least one shim element fixing protrusion (not shown). The shim element fixing protrusions may correspond to the shim element fixing holes 141 of the shim body 10. The shim element fixing protrusions may mate with the shim element fixing holes 141 which may help the additional shim element 40 to be positioned on and/or fixed to the shim body 10. In other examples, the additional shim element 40 may include the shim element fixing holes 141 and the shim body 10 may include the shim element fixing protrusions.

The additional shim element 40 may have a thickness of approximately 2 mm. In some examples, the additional shim element 40 may have a thickness larger than approximately 2 mm. In addition or alternatively, the additional shim element 40, the insert 20, and the recessed portion 14 may have a combined thickness of approximately 5.5 mm. However, in some examples, the additional shim insert 40, the insert 20, and the recessed portion 14 may be configured to have a combined thickness corresponding to a leg length discrepancy, which may be greater or less than approximately 5.5 mm.

In some examples, the additional shim element 40 may have a shape similar to that of the shim body. In addition or alternatively, the additional shim element 40 may include areas corresponding to the tread elements 11. However, in some examples, the areas corresponding to the tread elements 11 may be omitted. One or more additional shim elements 40 may be configured to stack together on the shim body thereby increasing the separation between the cleat and the sole of the cycling shoe with each additional shim element 40.

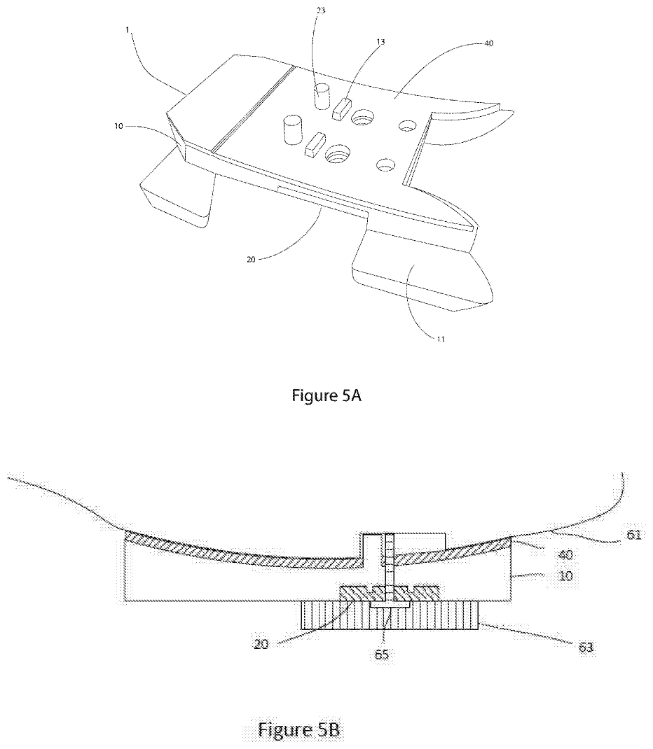

FIG. 5A illustrates an example of the leg length shim 1 including the shim body 10 and tread elements 11 as illustrated in FIGS. 1A to 1D, the insert 20 as illustrated in FIGS. 2A to 2C, and the additional shim element 40 as illustrated in FIGS. 4A and 4B. FIG. 5B is a cross-sectional view along a length of the leg length shim 1, which shows the relative arrangements of the sole of the cycling shoe 61, the shim body 10, the insert 20, the additional shim element 40, the cleat 63, and a fixing device 65.

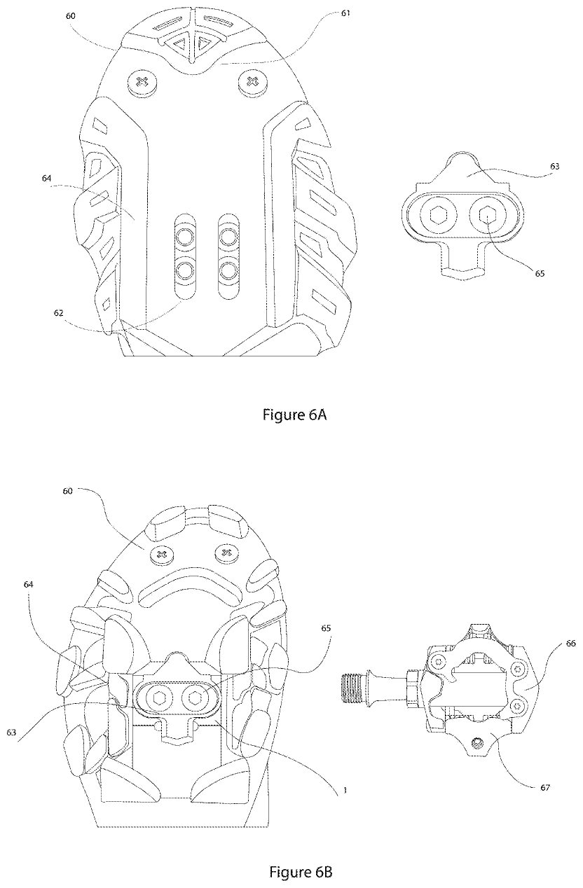

FIG. 6B illustrates an example of the leg length shim 1 coupled with the cycling shoe 60 and the cleat 63, and a pedal 66. The pedal 66 may include a pedal locking mechanism 67. The cleat 63 may be configured to lock into the pedal locking mechanism 67 to fix the cycling shoe 60 to the pedal 66. In some examples the cleat 63 may be configured to be coupled to the cycling shoe 60 with two fixing devices 65 (e.g. bolts). For instance, the cleat 63 may be of a Shimano SPD type. In other examples a Time ATAC or similar MTB style cleat could be used.

As will be appreciated from the above description, the leg length shim 1 may correct a leg length discrepancy. In addition, the leg length shim may prevent the cleat from contacting the ground when the cycling shoe is walked in. As such, the leg length shim 1 may protect the cleat from damage during walking. Furthermore, the leg length shim 1 may provide improved grip during walking. As such, the leg length shim 1 may improve a user's ability to walk when wearing the cycling shoe, particularly in off-road conditions which may include unstable surfaces.

The leg length shim 1 may allow the cleat to be easily “clipped in” and/or “clipped out” from the pedal locking mechanism of the pedal. The leg length shim 1 may not interfere with either one or both of these actions, which may include a forward sliding motion, a backward sliding motion, a downward motion, an upward motion, a side motion and/or a twisting motion. As such the leg length shim 1 may improve an ease of use of the cycling shoe.

The leg length shim may allow any debris which has been picked up during use of the cycling shoe to move away from the cleat so that the debris does not interfere with the cleat coming together with the pedal locking mechanism of the pedal.

The leg length shim 1 may prevent the leg length shim 1 from rotating when torque is applied to the cleat by a user (e.g. during “clipping in/out”, or cycling). As such, the leg length shim 1 may retain the proper positioning of the cleat and may improve an efficiency of cycling, and/or a user comfort.

The leg length shim 1 may be durable and hard wearing. The leg length shim 1 may also hold its shape even when it is not supported (e.g. by the tread of the cycling shoe). As such, the leg length shim 1 may be reliable and long lasting even when the leg length shim 1 is used in off-road conditions.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. A leg length shim for coupling to a sole of a cycling shoe in order to correct a leg length discrepancy, comprising:
a shim body having an upper surface and a lower surface, wherein, when the leg length shim is coupled to a sole of the cycling shoe, the upper surface faces towards the sole of the cycling shoe and the lower surface faces away from the sole of the cycling shoe; and
at least one tread element extending from the lower surface of the shim body in a direction away from the sole of the shoe, wherein at least some of the tread elements extend outside a perimeter of the shim body.

2. (canceled)

3. The leg length shim of claim 1, wherein at least some of the tread elements include a first portion and a second portion, wherein the first portion extends from the shim body to the second portion, and the second portion extends outside the perimeter of the shim body, and wherein, when the leg length shim is coupled to the sole of the cycling shoe, a lower surface of the second portion is configured to contact a surface upon which a wearer of the cycling shoe is walking.

4. The leg length shim of claim 3, wherein the first and second portions of the tread elements together define a volume for receiving a tread of a cycling shoe.

5. The leg length shim of claim 4, wherein an outer surface of the first portion and an upper surface of the second portion define the volume for receiving a tread of a cycling shoe, the outer surface of the first portion and the upper surface of the second portion sharing a common edge.

6. The leg length shim of claim 3, wherein the first portion and the second portion together form a channel for receiving a tread of the cycling shoe.

7. The leg length shim of claim 3, wherein the first portion extends generally away from the sole, and the second portion extends generally perpendicular to the sole.

8. The leg length shim of claim 3, wherein the first portion extends such that the second portion is further from the sole of the cycling shoe than is a bottom of a tread of the cycling shoe when the leg length shim is coupled to the sole of the cycling shoe.

9. The leg length shim of claim 1, wherein the tread elements comprise a guide edge, wherein the guide edge is positioned at a forward facing end of the tread elements, the forward facing end of the tread elements being an end of the tread elements closest to a front of the cycling shoe when the leg length shim is coupled to the sole of the cycling shoe, and wherein the guide edge is configured to guide a pedal locking mechanism of a pedal towards a cleat coupled to the cycling shoe.

10. The leg length shim of claim 1, wherein the tread elements comprise an angled edge configured to allow debris to pass more easily away from a cleat coupled to the cycling shoe.

11. The leg length shim of claim 1, wherein the tread elements are formed of a material having at least one of: a high abrasion resistance, a high coefficient of friction, and a high shear strength.

12. The leg length shim of claim 1 further comprising at least one mating protrusion protruding from an upper surface of the shim body,
wherein each of the at least one mating protrusion is configured to mate with a hole of the cycling shoe in order to prevent the shim from rotating when torque is applied during cycling.

13. The leg length shim of claim 1, wherein the tread elements comprise two front feet, wherein the front feet are positioned at a front end of the shim body and are spaced apart from one another.

14. (canceled)

15. The leg length shim of claim 13, wherein the tread elements further comprise two rear feet.

16. (canceled)

17. The leg length shim of claim 15, wherein the front feet are spaced apart from the rear feet.

18. The leg length shim of claim 13, wherein the tread elements further comprise a single rear foot.

19. (canceled)

20. The leg length shim of claim 1, further comprising a recessed portion in a lower surface of the shim body configured to receive an insert.

21. The leg length shim of claim 20 further comprising an insert configured to be inserted into the recessed portion.

22. The leg length shim of claim 21, wherein the insert is formed of a material which has a hardness greater than a hardness of a material forming the shim body.

23. (canceled)

24. (canceled)

25. The leg length shim of claim 1, wherein the shim body is formed of two components, each component having at least one tread element extending therefrom, wherein relative positions of the two components can be adjusted, thereby to adjust a width of the leg length shim.

26. The leg length shim of claim 1 comprising at least two tread elements wherein a first of the tread elements extends along one side of the shim body and a second of the tread elements extends an opposing side of the shim body.
